(19) United States
(12) Patent Application Publication
(10) Pub. No.: US 2026/0260600 A1
(43) Pub. Date: Sep. 3, 2026

(54) LIGHT EMITTING DISPLAY APPARATUS

(71) Applicant: LG Display Co., Ltd., Seoul (KR)

(72) Inventor: Junhwan Noh, Paju-si (KR)

(21) Appl. No.: 19/411,652

(22) Filed: Dec. 8, 2025

(30) Foreign Application Priority Data
Feb. 28, 2025 (KR) 10-2025-0026920

(51) Int. Cl. G09G 3/32

(52) U.S. Cl. CPC G09G 3/32; G09G 2300/0819; G09G 2310/0267; G09G 2320/0271; G09G 2320/064

(57) ABSTRACT

A light emitting display apparatus includes a pixel including a driving transistor, a light emitting device, and a first light emitting transistor connected between first terminals of the driving transistor and the light emitting device, and a gate driver to supply a light emitting signal for turning the first light emitting transistor on or off to a gate of the first light emitting transistor, in which in a low-luminance mode that outputs light having a luminance equal to or lower than a predetermined mode conversion luminance, a difference between a high voltage level and a low voltage level of a light emitting signal is greater than a first difference value, which is a difference between a first high voltage level and a first low voltage level of a light emitting signal in a high-luminance mode that outputs light having a luminance exceeding the mode conversion luminance.

### CROSS REFERENCE TO RELATED APPLICATION

This application claims priority from and the benefit of Korean Patent Application No. 10-2025-0026920, filed on Feb. 28, 2025, which is hereby incorporated by reference for all purposes as if fully set forth herein.

### BACKGROUND

### FIELD

Embodiments of the invention relate generally to a light emitting display apparatus.

### DISCUSSION OF THE BACKGROUND

Light emitting display apparatuses are mounted on or provided in electronic products such as televisions, monitors, notebook computers, smart phones, tablet computers, electronic pads, wearable devices, smart watch, portable information devices, navigation devices, or vehicle control display devices, etc., to display images. Pixels are provided in a light emitting display panel configuring a light emitting display apparatus, and a light emitting device is provided in each of the pixels.

To control the luminance of light output from a pixel, a PWM (Pulse Width Modulation) scheme may be applied. However, in a light emitting display apparatus to which the PWM scheme is applied, the low-gray-level response characteristics of a light emitting device may be degraded.

The above information disclosed in this Background section is only for understanding of the background of the inventive concepts, and, therefore, it may contain information that does not constitute prior art.

### SUMMARY

Accordingly, the present disclosure is directed to providing a light emitting display apparatus that substantially obviates one or more problems due to limitations and disadvantages of the related art.

An aspect of the present disclosure is directed to providing a light emitting display apparatus in which a difference between a high level and a low level of a light emitting signal in a low-luminance mode is greater than a difference between a first high level and a first low level of a light emitting signal in a high-luminance mode.

Additional features of the inventive concepts will be set forth in the description which follows, and in part will be apparent from the description, or may be learned by practice of the inventive concepts.

To achieve these and other advantages and in accordance with the purpose of the disclosure, as embodied and broadly described herein, there is provided in some embodiments a light emitting display apparatus comprising a pixel including a driving transistor, a light emitting device, and a first light emitting transistor connected between a first terminal of the driving transistor and a first terminal of the light emitting device and a gate driver configured to supply a light emitting signal for turning the first light emitting transistor on or off to a gate of the first light emitting transistor, wherein when the display apparatus is in a low-luminance mode that outputs light having a luminance equal to or lower than a predetermined mode conversion luminance, a difference between a high voltage level and a low voltage level of a light emitting signal is greater than a first difference value, which is a difference between a first high voltage level and a first low voltage level of a light emitting signal when the display apparatus is in a high-luminance mode that outputs light having a luminance exceeding the mode conversion luminance.

When the light emitting display apparatus is in the low luminance mode, the gate driver may output the light emitting signal in which at least four on-level voltage pulses and at least four off-level voltage pulses alternately occur in a kth frame (where k is a natural number).

In the light emitting display apparatus, a duration of each of the off-levels may change depending on a grayscale level.

In the light emitting display apparatus, when an average grayscale level of pixels in a kth frame is higher than an average grayscale level of pixels in a (k-1)th frame, a difference between a high voltage level and a low voltage level of the light emitting signal supplied in the kth frame in the low luminance mode may be greater than the first difference value.

In the light emitting display apparatus, when the first light emitting transistor is a P-type transistor, each of the off-level voltage pulses may be a high voltage level pulse, each of the on-level voltage pulses may be a low level voltage pulse, and a voltage of a kickback off-level voltage pulse among the off-level voltage pulses may be greater than the first high voltage level.

In the light emitting display apparatus, a difference between a voltage of an on-level voltage pulse supplied immediately before the kickback off-level voltage pulse of the light emitting signal and a voltage of the kickback off-level voltage pulse may be greater than the first difference value.

In the light emitting display apparatus, the pixel may further include an anode reset transistor connected between an anode reset line to which an anode reset voltage is supplied and a first terminal of the light emitting device, and the anode reset transistor may be turned on while the kickback off-level voltage pulse may be supplied to a gate of the first light emitting transistor.

In the light emitting display apparatus, among the off-level voltage pulses in the low luminance mode, a voltage of all off-level voltage pulses other than the kickback off-level voltage pulse, termed normal pulses, may be the same as the first high voltage level.

In the light emitting display apparatus, after the kickback off-level voltage pulse is supplied to a gate of the first light emitting transistor, the normal off-level voltage pulse may be supplied to the gate of the first light emitting transistor.

In the light emitting display apparatus, while a start off-level voltage pulse is supplied to a gate of the first light emitting transistor after a kth frame starts, a data voltage may be supplied to a gate of a driving transistor.

In the light emitting display apparatus, among the off-level voltage pulses in the low luminance mode, a voltage of a normal off-level voltage pulse other than the kickback off-level voltage pulse may be the same as the first high voltage level, and the normal off-level voltage pulse may be supplied to the gate of the first light emitting transistor between the first off-level voltage pulse and the kickback off-level voltage pulse.

In the light emitting display apparatus, a start off-level voltage pulse supplied to the gate of the first light emitting transistor in a (k+1)th frame generated after the kth frame may be the same as a second high voltage level of a light emitting signal in the (k+1)th frame when the display apparatus is in a high-luminance mode that outputs light having a luminance exceeding the mode conversion luminance.

In the light emitting display apparatus, an on-level voltage pulse supplied to a gate of the first light emitting transistor after the kickback off-level voltage pulse may be greater than the first low voltage level.

In the light emitting display apparatus, a voltage of an on-level voltage pulse supplied to a gate of the first light emitting transistor immediately before the kickback off-level voltage pulse may be the first low voltage level, and a voltage of an on-level voltage pulse supplied to the gate of the first light emitting transistor after the kickback off-level voltage pulse may be greater than the first low voltage level.

In the light emitting display apparatus, when the first light emitting transistor is a P-type transistor, an on-level voltage pulse supplied to a gate of the first light emitting transistor immediately before the kickback off-level voltage pulse among the off-level voltage pulses may be lower than the first low voltage level.

In the light emitting display apparatus, an on-level voltage pulse supplied to the gate of the first light emitting transistor after the kickback off-level voltage pulse may be greater than the first low voltage level.

In other embodiments, a light emitting display apparatus may comprise a light emitting display panel, a gate driver that supplies scan voltage signals to a plurality of scan lines provided to serve the display panel, a data driver that supplies data voltages to a plurality of data lines provided to serve the display panel, a control unit that controls driving of the gate driver and the data driver, and a power supply that supplies power to the control unit, the gate driver, the data driver and the display panel, wherein the display panel includes a plurality of pixels, each pixel comprising a driving transistor, a light emitting device, a first light emitting transistor, a source of the first light emitting transistor being connected to a drain of the driving transistor, a drain of the first light emitting transistor being connected to an anode of the light emitting device, a gate of the first light emitting transistor being connected to a first scan line known as a light emitting signal line, a first voltage source, a second light emitting transistor, a source of the second light emitting transistor being connected to the first voltage source, a drain of the second light emitting transistor being connected to the source of the driving transistor, a gate of the second light emitting transistor being connected to the light emitting signal line, a capacitor interposed between and directly connected to each of the first voltage source and a gate of the driving transistor, a first switching transistor interposed between the source of the driving transistor and a data line providing data voltages, a gate of the first switching transistor being connected to a second scan line providing scan voltage signals, an on-bias stress transistor interposed between the source of the driving transistor and an on-bias stress voltage source, a gate of the on-bias stress transistor being connected to a third scan line providing scan voltage signals, and a reset transistor interposed between a drain of the second light emitting transistor and the anode of the light emitting device, a gate of the reset transistor being connected to the third scan line, wherein providing an on-bias stress voltage from the on-bias stress voltage source to the driving transistor reduces a change in characteristics of the driving transistor due to hysteresis.

The light emitting display apparatus may further comprise an initialization transistor interposed between the gate of the driving transistor and an initialization voltage source, a gate of the initialization transistor being connected to a fourth scan line, a threshold voltage compensation transistor interposed directly between the gate and a drain of the driving transistor, a gate of the threshold voltage compensation transistor being connected to a fifth scan line, and a second voltage source connected to a cathode of the light emitting device.

In other embodiments, a method of improving picture quality in a light emitting display apparatus may comprise providing a light emitting display apparatus wherein the light emitting display apparatus has a plurality of pixels, each pixel including one or more light emitting transistor(s), wherein voltage signals via a light emission signal line to a gate of each light emitting transistor causes light emission by the pixel to turn on and turn off, and the light emitting display apparatus can operate in a low luminance mode when luminance is equal to or lower than a predetermined mode conversion luminance or can operate in a high luminance mode when luminance is higher than the mode conversion luminance, and controlling light emission of the pixel by applying a light emitting voltage signal to the light emission signal line, wherein when the display apparatus is in a low luminance mode, a difference between a high voltage level and a low voltage level of a light emitting signal is greater than a first difference value, which is a difference between a first high voltage level and a first low voltage level of a light emitting signal when the display apparatus is in a high luminance mode.

In the method of improving picture quality, when the display apparatus is in the low luminance mode, the light emitting voltage signal may feature at least four on-level voltage pulses and at least four off-level voltage pulses that alternately occur in a kth frame (where k is a natural number).

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is an example diagram illustrating a configuration of a light emitting display apparatus according to an embodiment of the present disclosure.

FIG. 2 is an example diagram illustrating a structure of a pixel applied to a light emitting display apparatus according to an embodiment of the present disclosure.

FIG. 3 is an example diagram illustrating a structure of a control unit applied to a light emitting display apparatus according to an embodiment of the present disclosure.

FIG. 4 is an example diagram illustrating a structure of a gate driver applied to a light emitting display apparatus according to an embodiment of the present disclosure.

FIG. 5 is an example diagram illustrating a structure of a data driver applied to a light emitting display apparatus according to an embodiment of the present disclosure.

FIG. 6 is an exemplary diagram for describing features applied to a light emitting display apparatus according to an embodiment of the present disclosure.

FIG. 7 is an exemplary diagram for explaining a PWM method applied to a light emitting display apparatus according to an embodiment of the present disclosure.

FIG. 8 is an exemplary diagram illustrating signals applied to a light emitting display apparatus to which a PWM method is applied.

FIG. 9 is an exemplary diagram for explaining a problem that can occur when signals illustrated in FIG. 8 are used in a low luminance mode.

FIG. 10 is an exemplary diagram for explaining a basic driving method of a light emitting display apparatus according to an embodiment of the present disclosure.

FIG. 11 is an exemplary diagram illustrating a driving method of a light emitting display apparatus according to an embodiment of the present disclosure.

FIG. 12 is another exemplary diagram for explaining a driving method of a light emitting display apparatus according to an embodiment of the present disclosure.

FIGS. 13 and 14 are other exemplary diagrams for describing a method for driving a light emitting display apparatus according to an embodiment of the present disclosure.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z – axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Hereinafter, embodiments of the present disclosure will be described in detail with reference to the accompanying drawings.

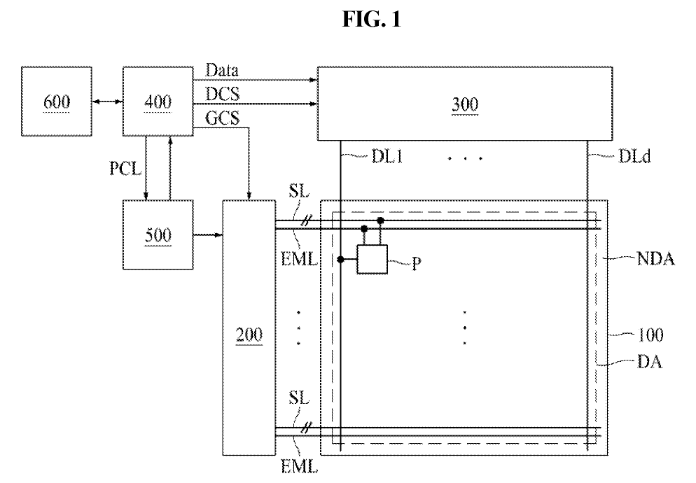

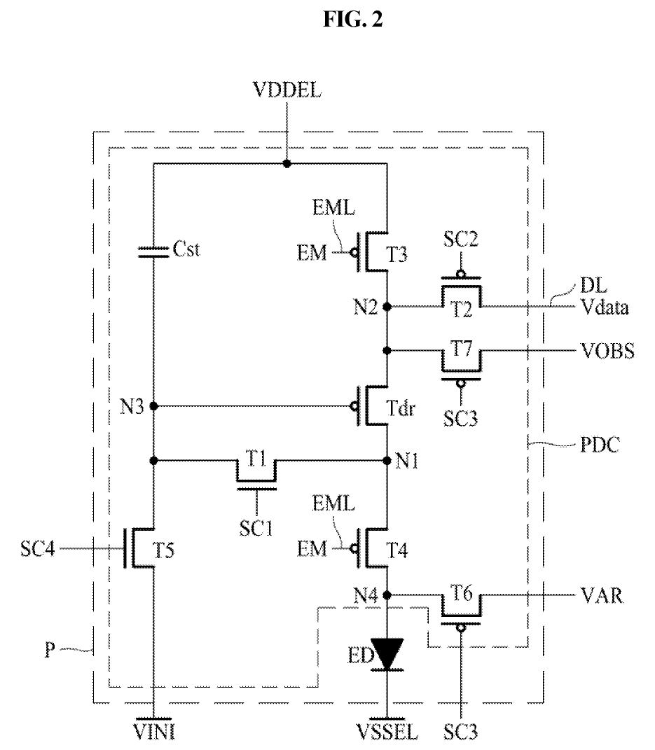

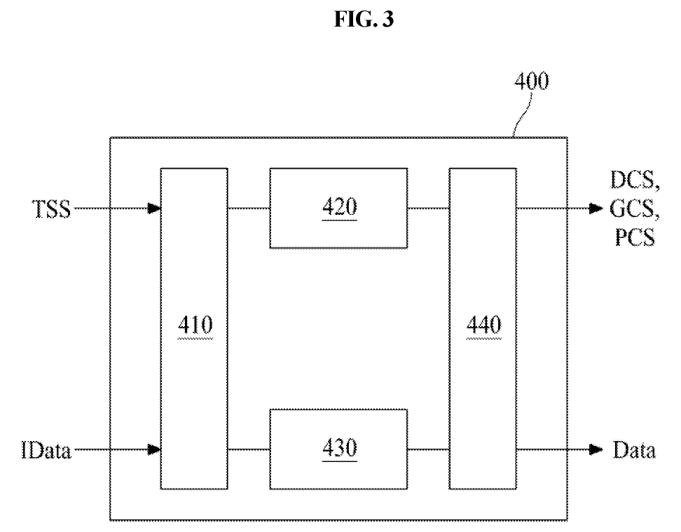

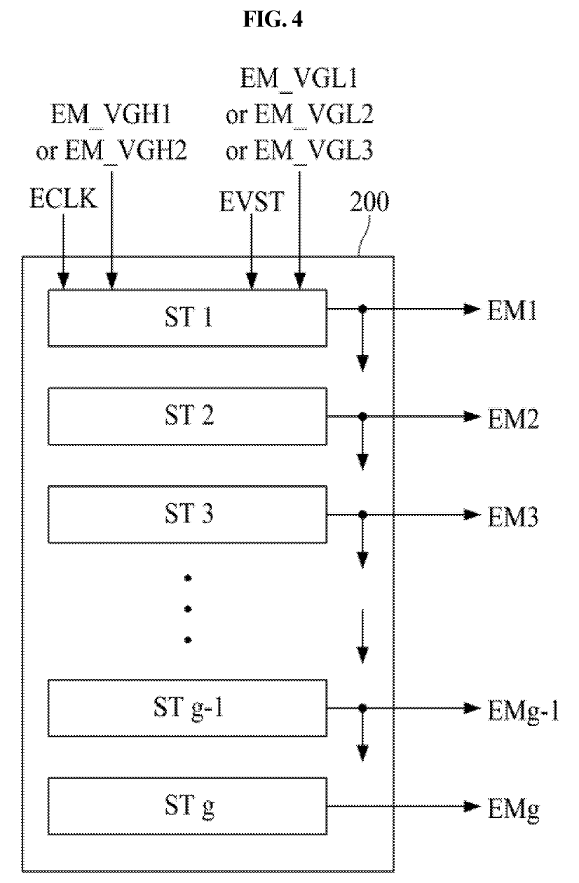

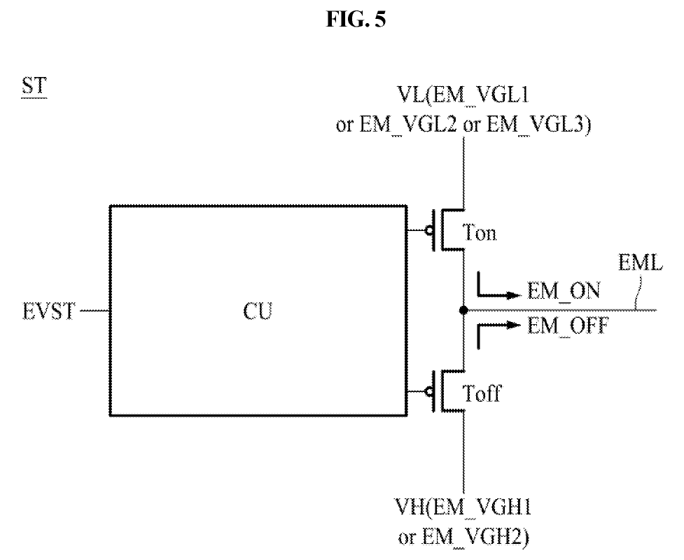

FIG. 1 is an example diagram illustrating a configuration of a light emitting display apparatus according to an embodiment of the present disclosure, FIG. 2 is an example diagram illustrating a structure of a pixel applied to a light emitting display apparatus according to an embodiment of the present disclosure, FIG. 3 is an example diagram illustrating a structure of a control unit applied to a light emitting display apparatus according to an embodiment of the present disclosure, FIG. 4 is an example diagram illustrating a structure of a gate driver applied to a light emitting display apparatus according to an embodiment of the present disclosure, and FIG. 5 is an example diagram illustrating a structure of a data driver applied to a light emitting display apparatus according to an embodiment of the present disclosure.

A light emitting display apparatus according to an embodiment of the present disclosure can be used in various kinds of electronic devices. Electronic devices can be, for example, televisions, monitors, etc.

The light emitting display apparatus according to an embodiment of the present disclosure, as illustrated in FIGS. 1 and 2, can include a light emitting display panel 100 which includes a display area DA displaying an image and a non-display area NDA provided outside the display area DA, a gate driver 200 which supplies scan signals to a plurality of scan lines SL provided in the display area DA of the display panel 100, a data driver 300 which supplies data voltages Vdata to a plurality of data lines DL1 to DLd provided in the display area DA of the display panel 100, a control unit 400 which controls driving of the gate driver 200 and the data driver 300, and a power supply unit 500 which supplies power to the control unit 400, the gate driver 200, the data driver 300, and the light emitting display panel 100.

First, the light emitting display panel 100 can include a display area DA and a non-display area NDA. Scan lines SL, light emitting signal lines EML, data lines DL1 to DLd, and pixels P can be provided in the display area DA. Here, d is a natural number. Accordingly, an image can be displayed in the display area DA. The non-display area NDA can surround the outer periphery of the display area DA.

The pixel P included in the light emitting display panel 100, as illustrated in FIG. 2, can include a pixel driving circuit PDC, which includes transistors T1 to T7 and Tdr, and a light emitting device ED connected to the pixel driving circuit PDC.

A first terminal of the driving transistor Tdr can be connected to a first node N1, a second terminal of the driving transistor Tdr can be connected to a second node N2, and a gate of the driving transistor Tdr can be connected to a third node N3.

A first light emitting transistor T4 can be connected between the first terminal of the driving transistor Tdr and a first terminal of the light emitting device ED. For example, a first terminal of the first light emitting transistor T4 can be connected to the first terminal of the driving transistor Tdr, a second terminal of the first light emitting transistor T4 can be connected to the first terminal of the light emitting device ED, and a gate of the first light emitting transistor T4 can be connected to the light emitting signal line EML. Here, the first electrode of the light emitting device ED can be an anode, and the first electrode can be connected to a fourth node N4. Accordingly, the fourth node N4 can be an anode. A light emitting signal EM generated by the gate driver 200 can be supplied to the gate of the first light emitting transistor T4.

A first terminal of a second light emitting transistor T3 can be connected to a line to which a first voltage VDDEL is supplied, a second terminal of the second light emitting transistor T3 can be connected to the second terminal of the driving transistor Tdr, and a gate of the second light emitting transistor T3 can be connected to the light emitting signal line EML. The light emitting signal EM can be supplied to the gate of the second light emitting transistor T3.

A first terminal of a switching transistor T2 can be connected to a data line DL to which a data voltage Vdata is supplied, a second terminal of the switching transistor T2 can be connected to the second node N2, and a gate of the switching transistor T3 can be connected to a line to which a second scan signal SC2 is supplied.

A first terminal of a threshold voltage compensation transistor T1 can be connected to the third node N3, a second terminal of the threshold voltage compensation transistor T1 can be connected to the first node N1, and a gate of the threshold voltage compensation transistor T1 can be connected to a line to which a first scan signal SC1 is supplied.

A first terminal of an initialization transistor T5 can be connected to the third node N3, a second terminal of the initialization transistor T5 can be connected to a line to which an initialization voltage VINI is supplied, and a gate of the initialization transistor T5 can be connected to a line to which a fourth scan signal SC4 is supplied.

A first terminal of an on-bias stress transistor T7 can be connected to the second node N2, a second terminal of the on-bias stress transistor T7 can be connected to a line to which an on-bias stress voltage VOBS is supplied, and a gate of the on-bias stress transistor T7 can be connected to a line to which a third scan signal SC3 is supplied.

A first terminal of a reset transistor T6 can be connected to the fourth node N4, a second terminal of the reset transistor T6 can be connected to a line to which an anode reset voltage VAR is supplied, and a gate of the reset transistor T6 can be connected to a line to which the third scan signal SC3 is supplied.

A first terminal of a storage capacitor Cst can be connected to a line to which the first voltage VDDEL is supplied, and a second terminal of the storage capacitor Cst can be connected to the third node N3.

Each of the first scan signal SC1, the second scan signal SC2, the third scan signal SC3, and the fourth scan signal SC4 can be generated by the gate driver 200 and supplied to the pixel P through a scan line SL. Accordingly, each of the lines through which the first scan signal SC1, the second scan signal SC2, the third scan signal SC3, and the fourth scan signal SC4 are supplied can be a scan line SL.

The transistors included in the pixel driving circuit PDC can have the same type. However, as illustrated in FIG. 2, some transistors T2 to T4, T6, T7, and Tdr can be formed in a P type, and other transistors T1 and T5 can be formed in an N type. However, this is exemplary, and the types of transistors are not limited thereto.

The light emitting device ED can include a first electrode connected to the fourth node N4, a second electrode connected to a line through which a second voltage VSSEL is supplied, and a light emitting layer provided between the first electrode and the second electrode. The first electrode can be an anode and the second electrode can be a cathode.

The structure of the pixel P applied to a light emitting display apparatus according to an embodiment of the present disclosure is not limited to the structure illustrated in FIG. 2. Accordingly, the structure of the pixel P can be changed to various shapes according to design implementation. However, in the following, for convenience of description, a light emitting display apparatus including the pixel P illustrated in FIG. 2 is described as a light emitting display apparatus according to an embodiment of the present disclosure.

The control unit 400 can realign input data signals IData transmitted from an external system 600 by using a timing synchronization signal TSS transmitted from the external system and can generate a data control signal DCS which is to be supplied to the data driver 300 and a gate control signal GCS which is to be supplied to the gate driver 200.

To this end, as illustrated in FIG. 3, the control unit 400 can include a data aligner 430 which realigns input data signals IData to generate data signal Data, a control signal generator 420 which generates the gate control signal GCS and the data control signal DCS by using the timing synchronization signal TSS, an input unit 410 which transmits the timing synchronization signal TSS transmitted from the external system 600 to the control signal generator 420 and transmits the input data signals IData transmitted from the external system 600 to the data aligner 430, and an output unit 440 which supplies the data driver 300 with the data signal Data generated by the data aligner 430 and the data control signal DCS generated by the control signal generator 420 and supplies the gate driver 200 with the gate control signal GCS generated by the control signal generator 420.

The control signal generator 420 can generate a power control signal PCS supplied to the power supply unit 500. In particular, the control signal generator 420 can generate the power control signal PCS based on a result of analyzing the input data signals IData.

The external system 600 can perform a function of driving the control unit 400 and an electronic device.

The power supply unit 500 can generate various powers and supply the generated powers to the control unit 400, the gate driver 200, the data driver 300, and the light emitting display panel 100.

For example, the power supply unit 500 can generate high and low voltages used to generate a light emitting signal EM, and can transmit the high and low voltages to the gate driver 200 or the control unit 400.

In particular, the power supply unit 500 can generate at least one high voltage and at least one low voltage.

In addition, the power supply unit 500 can transmit the high voltage and the low voltage selected by the power control signal PCS to the gate driver 200 or the control unit 400.

The data driver 300 can supply data voltages Vdata to the data lines DL1 to DLd.

Finally, the gate driver 200 can be directly embedded into the non-display area NDA by using a gate-in panel (GIP) type, or the gate driver 200 can be provided in the display area DA in which light emitting devices ED are provided, or the gate driver 200 can be provided on a chip on film mounted in the non-display area NDA.

The gate driver 200 can supply the scan signals SC1 to SC4 to a pixel P through the scan lines SL. For example, four scan lines SL to which four scan signals SC1 to SC4 are supplied can be connected to the pixel P illustrated in FIGS. 1 and 2.

Also, the gate driver 200 can supply the light emitting signal EM to the pixel P through the light emitting signal line EML. For example, one light emitting signal line EML to which one light emitting signal EM is supplied can be connected to the pixel P illustrated in FIGS. 1 and 2. In this case, one light emitting signal line EML can be connected to the gate of the first light emitting transistor T4 and the gate of the second light emitting transistor T3.

In order to sequentially supply the light emitting signals EM to the light emitting signal lines EML, the gate driver 200 can include stages ST1 to STg connected to the light emitting signal lines EML, as illustrated in FIG. 4.

Each of the stages ST1 to STg can be connected to one light emitting signal line EML, but can also be connected to at least two light emitting signal lines EML. For example, in the light emitting display apparatus to which the pixel P illustrated in FIG. 2 is applied, each of the stages ST1 to STg can be connected to one light emitting signal line EML.

In order to generate the light emitting signals EM1 to EMg (g is a natural number greater than 1), a start signal EVST and at least one clock ECLK generated in the control signal generator 420 can be transmitted to the gate driver 200. That is, the start signal EVST and the at least one clock ECLK can be included in the gate control signal GCS.

One of the stages ST1 to STg can be driven by the start signal EVST transmitted from the control unit 400 to output the light emitting signal EM to the light emitting signal line EML. The remaining stages can be driven by a start signal EVST transmitted from the previous stage to output the light emitting signal EM to the light emitting signal line EML.

The light emitting signal EM can include an on-level capable of turning on the first light emitting transistor T4 and an off-level capable of turning off the first light emitting transistor T4. When the on-level has a high-level voltage (hereinafter simply referred to as a high level), the off-level can have a low-level voltage (hereinafter simply referred to as a low level). Also, when the on-level has a low level, the off-level can have a high level.

The on-level and the off-level can be generated by a high voltage and a low voltage supplied from the power supply unit 500 to the gate driver 200.

For example, in a light emitting display apparatus to which the pixel P illustrated in FIG. 2 is applied, the gate driver 200 can generate an on-level low level by using a low voltage transmitted from the power supply unit 500 and an off-level by using a high voltage transmitted from the power supply unit 500.

To this end, each of the stages ST can include a turn-on transistor Ton, a turn-off transistor Toff, and a circuit unit CU, as illustrated in FIG. 5. The circuit unit CU can receive a start signal EVST to control the turn-on transistor Ton and the turn-off transistor Toff.

When the turn-on transistor Ton is turned on and the turn-off transistor Toff is turned off, a low voltage VL can be outputted to the light emitting signal line EML, and when the turn-off transistor Toff is turned on and the turn-on transistor Ton is turned off, the high voltage VH can be outputted to the light emitting signal line EML.

In this case, the low voltage VL output to the light emitting signal line EML can be an on-level EM_ON (e.g., a low level), and the high voltage VH output to the light emitting signal line EML can be an off-level EM_OFF (e.g., a high level). The first light emitting transistor T4 can be turned on by the on-level EM_ON, and the first light emitting transistor T4 can be turned off by the off-level EM_OFF.

However, the on-level EM_ON of the light emitting signal can be generated by a gate clock ECLK formed by a low voltage VL supplied from the power supply unit 500. In this case, the gate clock ECLK can be generated by the control unit 400, and can be supplied to the turn-on transistor Ton instead of the low voltage VL illustrated in FIG. 5.

Hereinafter, for convenience of description, a light emitting display apparatus including a stage ST, which generates an on-level EM_ON and an off-level EM_OFF by using a low voltage VL and a high voltage VH, respectively, transmitted from the power supply unit 500, as illustrated in FIG. 5, is described as a light emitting display apparatus according to an embodiment of the present disclosure. Though not specifically described herein, other embodiments are not excluded from the present disclosure.

In this case, the power supply unit 500 can generate at least one low voltage VL and at least one high voltage VH, and can transmit the low voltage VL and the high voltage VH selected by the power control signal PCS to the gate driver 200.

For example, as illustrated in FIGS. 4 and 5, the power supply unit 500 can generate three low voltages EM_VGL1, EM_VGL2, and EM_VGL3 and two high voltages EM_VGH1 and EM_VGH2.

In this case, each of the three low voltages EM_VGL1, EM_VGL2, and EM_VGL3 can be on-level EM_ON, and each of the two high voltages EM_VGH1 and EM_VGH2 can be off-level EM_OFF. However, this is merely illustrative, and the number of the low voltages and high voltages is not limited thereto, and the power supply unit 500 can select and output required voltages from among the low voltages and the high voltages of various levels depending on a predetermined condition.

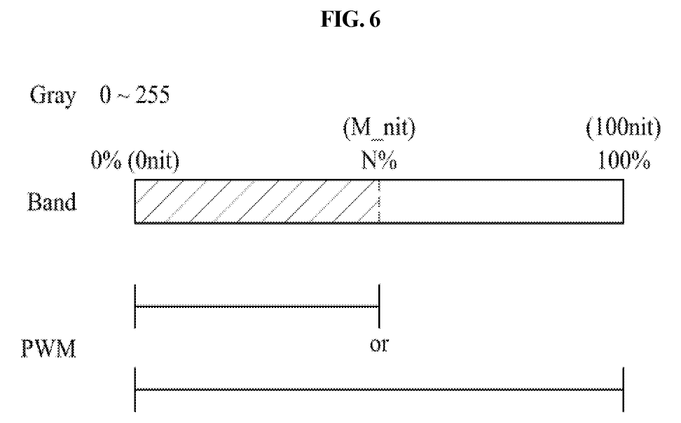

Hereinafter, a basic driving method of a light emitting display apparatus according to an embodiment of the present disclosure will be described with reference to FIGS. 6 to 9.

FIG. 6 is an exemplary diagram for describing features applied to a light emitting display apparatus according to an embodiment of the present disclosure.

As illustrated in FIGS. 6, 256 grayscale levels, a function to change the maximum luminance (e.g., luminance of grayscale level 255) of the light emitting device ED, and a pulse width modulation (PWM) method for adjusting the grayscale level are applied to a light emitting display apparatus according to an embodiment of the present disclosure.

For example, the luminance of light output from a pixel P can be divided into 256 grayscale levels (grayscale levels 0 to 255). In this case, the luminance of light gradually increases from grayscale level 0 to grayscale level 255.

When the maximum luminance of light output from a light emitting device ED is 100 nits, 100 nits can be 100% of the luminance of the light emitting device ED. The user can select the luminance of the light emitting device ED through a band illustrated in FIG. 6 provided in an electronic device including a light emitting display apparatus. Accordingly, the total luminance of an image outputted from the light emitting display panel 100 can be controlled. Hereinafter, the luminance selected by the user is referred to as user-set luminance.

For example, a user who feels eyestrain due to too high luminance of light output from a light emitting display apparatus can lower luminance through a band. For example, the user can select a luminance of 40% (e.g., luminance of 40 nit) as the user-set luminance.

Also, a user whose luminance of light output from a light emitting display apparatus is too low to clearly recognize an image output from the light emitting display apparatus can increase luminance through a band. For example, the user can select 100% luminance (e.g., luminance of 100 nit) as the user-set luminance.

The input data signal IData can correspond to any one of 256 grayscale levels, and light having a luminance corresponding to a user-set luminance can be output from the pixel P by the input data signal ID data corresponding to grayscale level 255.

For example, when the user selects 40% of the luminance as the user-set luminance and then receives an input data signal IData corresponding to grayscale level 255, the control unit 400 can generate the data signal data corresponding to grayscale level 255 and transmit the data signal to the data driver 300. The data driver 300 can generate the data voltage Vdata corresponding to grayscale level 255 and supply the data voltage Vdata to the pixel P.

In this case, light having a luminance corresponding to 40% of the maximum luminance can be output from the pixel P to which the data voltage Vdata is transmitted

In the light emitting display apparatus according to an embodiment of the present disclosure, the PWM method can be applied. In this case, the PWM method can be applied to all bands (0% to 100%). However, as illustrated in FIG. 6, among the luminance values between the maximum luminance (100 nits) and the minimum luminance (0 nits) of the light emitting device ED, the PWM method can be applied to a luminance equal to or lower than a luminance set during the process of manufacturing the light emitting display apparatus (hereinafter, simply referred to as mode conversion luminance (N% or M nit, where N and M are natural numbers)).

For example, in the process of manufacturing a light emitting display apparatus, one of the luminance values between the maximum luminance (100%) and the minimum luminance (0%) of the light emitting device ED can be set to the mode conversion luminance (N%). The control unit 400 can store information on the mode conversion luminance (N%).

When the user-set luminance selected by the user is less than or equal to the mode conversion luminance (N%), the control unit 400 can output light by applying the PWM method.

In the following description, a low luminance mode means a mode in which the light emitting device ED outputs light less than or equal to the mode conversion luminance (N%), and a high luminance mode means a mode in which the light emitting device ED outputs light exceeding the mode conversion luminance (N%).

Accordingly, when the light emitting display apparatus is driven in the low luminance mode by the user, the control unit 400 can output light by applying the PWM method.

As described above, in a light emitting display apparatus according to an embodiment of the present disclosure, the PWM method can be applied to any of the possible bands (0% to 100%), but the PWM method can be applied only when the user-set luminance is less than or equal to the mode conversion luminance (N%).

For example, in the low luminance mode, it can be difficult to express all grayscale levels only by changing the data voltage Vdata. Accordingly, in the low luminance mode, the PWM method can be applied, and all grayscale levels can be expressed even in the low luminance mode by applying the PWM method.

Hereinafter, for convenience of description, a light emitting display apparatus in which the PWM method is applied only when the user-set luminance is less than or equal to the mode conversion luminance (N%) will be described as an embodiment of the present disclosure.

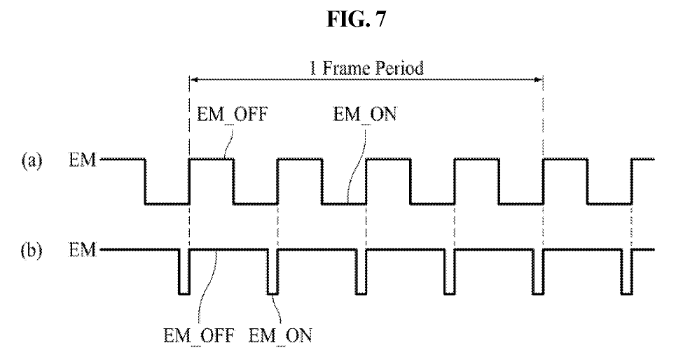

FIG. 7 is an exemplary diagram for explaining a PWM method applied to a light emitting display apparatus according to an embodiment of the present disclosure, and in particular, an exemplary diagram for explaining a PWM method applied to a light emitting display apparatus including the pixel P illustrated in FIG. 2.

When the PWM method is applied, in a light emitting display apparatus according to an embodiment of the present disclosure, as illustrated in FIG. 7 with time as the abscissa, four on-level intervals EM_ON and four off-level intervals EM_OFF can be supplied to the gate of the first light emitting Transistor T4 in one frame period. One frame period can mean a period in which all light emitting devices ED provided on the light emitting display panel 100 are driven to output one image.

The first light emitting transistor T4 can be turned on by the on-level EM_ON, and the first light emitting transistor T4 can be turned off by the off-level EM_OFF.

When the PWM method is applied, the width (time interval of application) of each on-level EM_ON pulse or the width of each off-level EM_OFF pulse can be changed over time as the image changes, depending on the grayscale level of the data signal Data.

For example, (a) of FIG. 7 represents a light emitting signal EM in a high grayscale level among 256 grayscale levels, where the mode conversion luminance is about 50% as shown in FIG. 6, and (b) of FIG. 7 represents a light emitting signal EM in a low grayscale level among 256 grayscale levels. The low grayscale level means lower grayscale level than the high grayscale level.

To provide an additional description, the width of the on-level EM_ON in the high grayscale level is greater than the width of the on-level EM_ON in the low grayscale level. As the width of the on-level EM_ON increases, the period during which the first light emitting transistor T4 is turned on can increase, and thus the period during which light is output from the light emitting device ED can increase, and thus the luminance of light output from the pixel P can appear to increase.

Therefore, in a light emitting display apparatus to which PWM methods are applied, a grayscale level can be expressed by controlling the width of the on-level EM_ON (or off-level EM_OFF) pulse applied as a gate signal to T3 and T4.

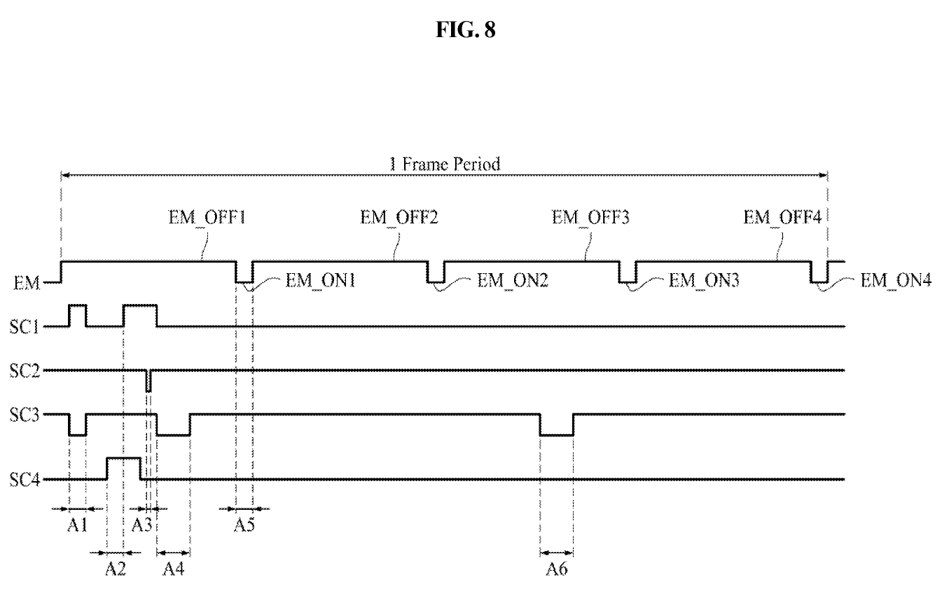

FIG. 8 is an exemplary diagram illustrating signals applied to a light emitting display apparatus to which a PWM method is applied, and in particular, an exemplary diagram illustrating signals applied to a low luminance mode.

As described above, in a light emitting display apparatus with mode conversion luminance (N%) set, PWM methods can be applied when the user-set luminance is less than or equal to the mode conversion luminance (N%), for example, in a low luminance mode.

When the PWM method is applied, as illustrated in FIG. 8, four off-levels EM_OFF1 to EM_OFF4 and four on-levels EM_ON1 to EM_ON4 can be supplied to the gate of the first light emitting transistor T4 and the gate of the second light emitting transistor T3 in one frame period.

First of all, in a first period A1, when a first off-level EM_OFF1 among the off-levels EM_OFF1 to EM_OFF4 having a high voltage level is supplied to the gate of the first light emitting transistor T4 and the gate of the second light emitting transistor T3, a first scan signal SC1 of a high voltage level is supplied to the gate of the threshold voltage compensation transistor T1, a second scan signal SC2 of a high voltage level is supplied to the gate of the switching transistor T2, a third scan signal SC3 of a low voltage level is supplied to the gate of the on-bias stress transistor T7 and the gate of the reset transistor T6, and a fourth scan signal SC4 of a low voltage level is supplied to the gate of the initialization transistor T5, the on-bias stress voltage VOBS can be supplied to the driving transistor Tdr, and the anode reset voltage VAR can be supplied to the anode of the light emitting device ED through the fourth node N4.

In the following description, the high and low voltage levels of the scan signals SC1 to SC4 need not be the same as the high voltage level forming the off-level and the low voltage level forming the on-level.

As the on-bias stress voltage VOBS is supplied to the driving transistor Tdr, a change in characteristics of the driving transistor Tdr due to hysteresis can be reduced.

Also, the anode of the light emitting device ED can be initialized by the anode reset voltage VAR supplied to the fourth node N4.

Next, in a second period A2, when a first off-level EM_OFF1 having a high level is supplied to the gate of the first light emitting transistor T4 and the gate of the second light emitting transistor T3, a first scan signal SC1 having a low voltage level is supplied to the gate of the threshold voltage compensation transistor T1, a second scan signal SC2 having a high voltage level is supplied to the gate of the switching transistor T2, a third scan signal SC3 having a high voltage level is supplied to the gate of the on-bias stress transistor T7 and the gate of the reset transistor T6, and a fourth scan signal SC4 having a high voltage level is supplied to the gate of the initialization transistor T5, the initialization voltage VINI is supplied to the gate of the driving transistor Tdr through the third node N3.

In this case, the gate of the driving transistor Tdr can be initialized by the initialization voltage VINI.

Next, in a third period A3, when a first off-level EM_OFF1 having a high voltage level is supplied to the gate of the first light emitting transistor T4 and the gate of the second light emitting transistor T3, a first scan signal SC1 having a high voltage level is supplied to the gate of the threshold voltage compensation transistor T1, a second scan signal SC2 having a low voltage level is supplied to the gate of the switching transistor T2, a third scan signal SC3 having a high voltage level is supplied to the gate of the on-bias stress transistor T7 and the gate of the reset transistor T6, and a fourth scan signal SC4 having a low voltage level is supplied to the gate of the initialization transistor T5, a data voltage Vdata can be supplied to the gate of the driving transistor Tdr through the second node N2, the first node N1, and the third node N3.

Accordingly, a data voltage Vdata can be charged in the gate of the driving transistor Tdr, and the threshold voltage of the driving transistor Tdr can be compensated.

Next, in a fourth period A4, when a first off-level EM_OFF1 having a high voltage level is supplied to the gate of the first light emitting transistor T4 and the gate of the second light emitting transistor T3, a first scan signal SC1 having a low voltage level is supplied to the gate of the threshold voltage compensation transistor T1, a second scan signal SC2 having a high voltage level is supplied to the gate of the switching transistor T2, a third scan signal SC3 having a low voltage level is supplied to the gate of the on-bias stress transistor T7 and the gate of the reset transistor T6, and a fourth scan signal SC4 having a low voltage level is supplied to the gate of the initialization transistor T5, the on-bias stress voltage VOBS can be supplied to the second terminal of the driving transistor Tdr through the second node N2, and the anode reset voltage VAR can be supplied to the anode of the light emitting device ED through the fourth node N4.

As the on-bias stress voltage VOBS is supplied to the second terminal of the driving transistor Tdr, a change in characteristics of the driving transistor Tdr due to hysteresis can be reduced.

Also, the anode of the light emitting device ED can be initialized by the anode reset voltage VAR supplied to the fourth node N4.

Next, in a fifth period A5, a first on-level EM_ON1 among the on-levels EM_ON1 to EM_ON4 having a low voltage level is supplied to the gate of the first light emitting transistor T4 and the gate of the second light emitting transistor T3. Accordingly, the first light emitting transistor T4 and the second light emitting transistor T3 can be turned on, and the driving transistor Tdr can be turned on according to the magnitude of the data voltage charged in the gate of the driving transistor Tdr.

Therefore, a current corresponding to the data voltage can be supplied to the light emitting device ED through the second light emitting transistor T3, the driving transistor Tdr, and the first light emitting transistor T4. Thus, light corresponding to the data voltage Vdata can be output from the light emitting device ED.

Next, a second off-level EM_OFF2 having a high voltage level is supplied to the gate of the first light emitting transistor T4 and the gate of the second light emitting transistor T3. Accordingly, the first light emitting transistor T4 and the second light emitting transistor T3 are turned off. Accordingly, light is not output from the light emitting device ED.

Next, a second on-level EM_ON2 having a low voltage level is supplied to the gate of the first light emitting transistor T4 and the gate of the second light emitting transistor T3. Accordingly, the first light emitting transistor T4 and the second light emitting transistor T3 can be turned on, and the driving transistor Tdr can be turned on according to the magnitude of the data voltage charged in the gate of the driving transistor Tdr.

Therefore, a current corresponding to the data voltage can be supplied to the light emitting device ED through the second light emitting transistor T3, the driving transistor Tdr, and the first light emitting transistor T4. Accordingly, light corresponding to the data voltage Vdata can be output from the light emitting device ED.

Next, in a sixth period A6, when a third off-level EM_OFF3 having a high voltage level is supplied to the gate of the first light emitting transistor T4 and the gate of the second light emitting transistor T3, a first scan signal SC1 having a low voltage level is supplied to the gate of the threshold voltage compensation transistor T1, a second scan signal SC2 having a high voltage level is supplied to the gate of the switching transistor T2, a third scan signal SC3 having a low voltage level is supplied to the gate of the on-bias stress transistor T7 and the gate of the reset transistor T6, and a fourth scan signal SC4 having a low voltage level is supplied to the gate of the initialization transistor T5, the on-bias stress voltage VOBS can be supplied to the second terminal of the driving transistor Tdr through the second node N2, and the anode reset voltage VAR can be supplied to the anode of the light emitting device ED through the fourth node N4.

Accordingly, the first light emitting transistor T4 and the second light emitting transistor T3 are turned off, and light is not output from the light emitting device ED.

In this case, as the on-bias stress voltage VOBS is supplied to the second terminal of the driving transistor Tdr, a change in characteristics of the driving transistor Tdr due to hysteresis can be reduced.

Also, the anode of the light emitting device ED can be initialized by the anode reset voltage VAR supplied to the fourth node N4.

Next, a third on-level EM_ON3 having a low voltage level is supplied to the gate of the first light emitting transistor T4 and the gate of the second light emitting transistor T3. Accordingly, the first light emitting transistor T4 and the second light emitting transistor T3 can be turned on, and the driving transistor Tdr can be turned on according to the magnitude of the data voltage charged in the gate of the driving transistor Tdr.

Thus, a current corresponding to the data voltage can be supplied to the light emitting device ED through the second light emitting transistor T3, the driving transistor Tdr, and the first light emitting transistor T4. Thus, light corresponding to the data voltage Vdata can be output from the light emitting device ED.

Next, a fourth off-level EM_OFF4 having a high voltage level is supplied to the gate of the first light emitting transistor T4 and the gate of the second light emitting transistor T3. Accordingly, the first light emitting transistor T4 and the second light emitting transistor T3 are turned off,, and light is not output from the light emitting device ED.

Finally, a fourth on-level EM_ON4 having a low voltage level is supplied to the gate of the first light emitting transistor T4 and the gate of the second light emitting transistor T3. Accordingly, the first light emitting transistor T4 and the second light emitting transistor T3 are turned on, and the driving transistor Tdr can be turned on according to the magnitude of the data voltage charged in the gate of the driving transistor Tdr.

Therefore, a current corresponding to the data voltage can be supplied to the light emitting device ED through the second light emitting transistor T3, the driving transistor Tdr, and the first light emitting transistor T4. Accordingly, light corresponding to the data voltage Vdata can be output from the light emitting device ED.

In this case, as described above, by controlling the width (duration) of the on-level EM_ON (or off-level EM_OFF) pulse, the amount of light output in one frame period can be controlled, and thus the luminance of light can be controlled.

Also, while the first and third off-levels EM_OFF1 and EM_OFF3 among the four off-level EM_OFF voltages are supplied to the gates of the first light emitting transistor T4 and the second light emitting transistor T3, the anode of the light emitting device ED can be reset by the anode reset voltage VAR, and accordingly, the light emitting device ED can be driven normally.

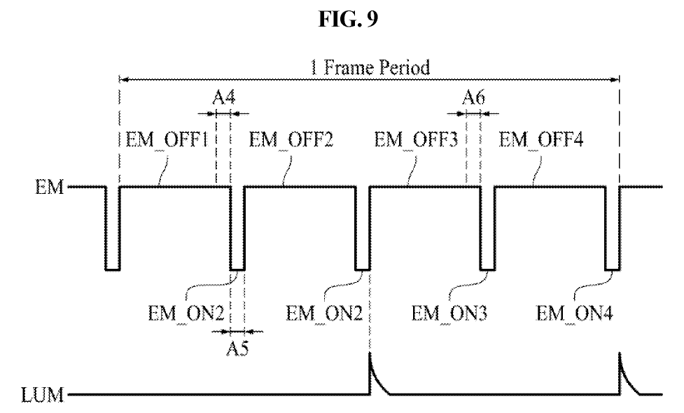

FIG. 9 is an exemplary diagram for explaining a problem that can occur when signals illustrated in FIG. 8 are used in a low luminance mode.

As described above, when light corresponding to the low grayscale level is output from the light emitting display apparatus to which the PWM method is applied, the width (duration) of the on-level EM_ON pulse is reduced, as illustrated in FIG. 9.

Here, the low grayscale level can mean a grayscale level lower than a specific grayscale level among grayscale levels 0 to 255. However, the low grayscale level can be variously changed depending on the user-set luminance set in the band described with reference to FIG. 6. In particular, problems described below can occur in the low luminance mode.

Also, as described with reference to FIG. 8, while the first off-level EM_OFF1 and the third off-level EM_OFF3 are supplied to the first light emitting transistor T4 and the second light emitting transistor T3, the anode of the light emitting device ED can be reset by the anode reset voltage VAR. For example, during the fourth period A4 and the sixth period A6, the anode of the light emitting device ED can be reset by the anode reset voltage VAR.

In this case, the anode reset voltage VAR can be a voltage much lower than the threshold voltage of the light emitting device ED.

Therefore, even if the first on-level EM_ON1 pulse is supplied during the fifth period A5 after a data voltage Vdata corresponding to a first low grayscale level is charged in the gate of the driving transistor Tdr while the first off-level EM_OFF1 pulse is supplied and the anode is reset by the anode reset voltage VAR, the voltage at the anode is unlikely to exceed the threshold voltage of the light emitting device ED. Therefore, light is not output in the fifth period A5. For example, when the first low grayscale level is grayscale level 2, the luminance LUM of light output from the light emitting device ED can be zero.

Also, because the width (duration) of the on-level EM_ON pulse in the low grayscale level is much smaller than the width (duration) of the on-level EM_ON pulse in the high grayscale level, light is not output while the second on-level EM_ON2 pulse is supplied, and light can be output from the time when the third off-level EM_OFF3 pulse is supplied. However, because the period in which light is output is very short in comparison with the frame period, the perceived luminance LUM of light from the display device for the subject pixel is very small.

Also, because the anode is reset again by the anode reset voltage VAR in the sixth period A6 in which the third off-level EM_OFF3 pulse is supplied, even if the third on-level EM_ON3 pulse is supplied after the sixth period A6, the voltage of the anode is unlikely to be higher than the threshold voltage of the light emitting device ED. Accordingly, light is not output even while the third on-level EM_ON3 pulse is supplied. Accordingly, the luminance LUM of the light emitting device ED is close to zero.

Light is not output while the fourth off-level EM_OFF4 pulse is supplied.

Also, while the fourth on-level EM_ON4 pulse is being supplied, light is not output as in the case where the second on-level EM_ON2 pulse is supplied, and substantially, light can be output from the time point when the fourth off-level EM_OFF4 pulse is supplied. However, because the period in which light is output is very short, the perceived luminance LUM of light from the display device for the subject pixel is very small.

Therefore, even if the light output after the second on-level EM_ON2 pulse is supplied and the light output after the fourth on-level EM_ON4 pulse is supplied are combined, the luminance corresponding to the first low grayscale level may not be generated.

The above-described problem can occur to noticeable effect, especially when low-grayscale level light is output from the light emitting device ED and then high-grayscale level light is output.

In the following description, a high grayscale level means a voltage higher than a low grayscale level. For example, when the range of grayscale levels is from grayscale level 0 to grayscale level 255, grayscale level 31 can be a high grayscale level and grayscale level 29 can be a low grayscale level compared to grayscale level 30. Also, grayscale level 21 can be a high grayscale level and grayscale level 19 can be a low grayscale level compared to grayscale level 20. Also, grayscale level 255 can be a high grayscale level and grayscale level 253 can be a low grayscale level compared to grayscale level 254.

For example, in a low grayscale level with a low voltage charged in the anode, in order to output high-grayscale level light, the voltage of the anode has to be increased quickly. However, in a low grayscale level of the low luminance mode, the voltage charged in the anode is low. Therefore, in the low luminance mode, when the low grayscale level is changed to high grayscale level, it is difficult to quickly charge the anode with a sufficient voltage. Accordingly, it is difficult to output light having a luminance corresponding to a high grayscale level.

In this case, the luminance corresponding to the high grayscale level means the combined luminance of light generated after the second on-level EM_ON2 pulse illustrated in FIG. 9 is supplied and light generated after the fourth on-level EM_ON4 pulse is supplied.

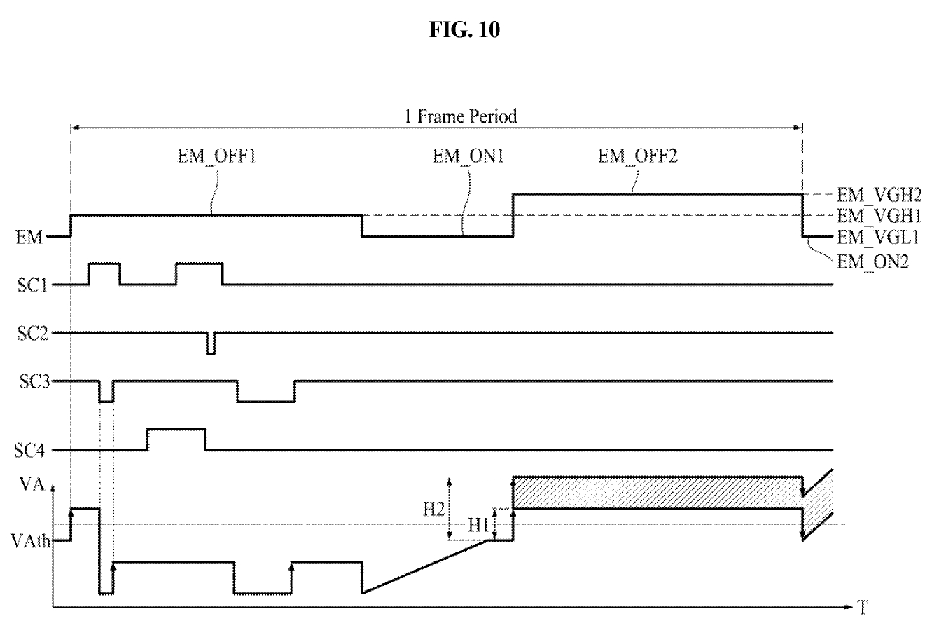

FIG. 10 is an exemplary diagram for explaining a basic driving method of a light emitting display apparatus according to an embodiment of the present disclosure, and particularly, an exemplary diagram illustrating signals applied to a light emitting display apparatus driven in a low luminance mode. In the following descriptions, details that are the same as or similar to those described with reference to FIGS. 1 to 9 are omitted or briefly described.

As described above, in the light emitting display apparatus according to an embodiment of the present disclosure, the mode conversion luminance (N%) is set, and the user-set luminance can be changed by a user. Furthermore, in the light emitting display apparatus according to an embodiment of the present disclosure, in the low luminance mode outputting light having a luminance the same as or less than the mode conversion luminance, the luminance of light is controlled by the PWM method, and accordingly, for example, grayscale levels 0 to 255 can be expressed.

The content described below is applied in the low luminance mode, and more particularly, can be applied when the grayscale level corresponding to the pixel P is changed from low grayscale level to high grayscale level. Also, as described above, high grayscale level described below means a voltage higher than low grayscale level. That is, high grayscale level and low grayscale level described below do not mean grayscale level in a specific range. In FIG. 10, a light emitting signal EM, a first scan signal SC1, a second scan signal SC2, a third scan signal SC3, and a fourth scan signal SC4 is illustrated, and a graph illustrating a change in the voltage VA of an anode are illustrated.

When a low grayscale level of a low luminance mode is expressed, in one frame period, four on-level EM_ON pulses and four off-level EM_OFF pulses can be supplied to the pixel P, as described with reference to FIG. 8.

In a low grayscale level, a driving method when the first off-level EM_OFF1 is supplied to the first light emitting transistor T4 and the second light emitting transistor T3 is the same as the driving method described with reference to FIG. 8. The first off-level EM_OFF1 is referred to as a first high level EM_VGH1.

In this case, as illustrated in FIG. 10, even if the first on-level EM_ON1 pulse is supplied, the voltage VA of the anode can be lower than the threshold voltage VAth of the anode. Accordingly, even if the first on-level EM_ON1 pulse is supplied, light is not output from the light emitting device ED.

When the second off-level EM_OFF2 pulse starts to be supplied to the first light emitting transistor T4 after the first on-level EM_ON1 pulse is supplied, the voltage of the fourth node N4 is increased by the gate-to-source kickback (hereinafter simply referred to as a kickback), and thus the voltage of the anode can be increased.

For example, the kickback can mean that the voltage of the second terminal N4 of the first light emitting transistor T4 increases as much as the voltage applied to the gate of the first light emitting transistor T4 increases.

In this case, if the second off-level EM_OFF2 pulse is the same as the first high level EM_VGH1 pulse, as illustrated in FIG. 10, the voltage of the anode can be increased by H1. However, even if the anode voltage is increased by H1, the voltage of the anode can be less than the threshold voltage VAth of the light emitting device ED, or light corresponding to the low grayscale level may not be output.

Therefore, in the light emitting display apparatus according to the present disclosure, in order to sufficiently increase the voltage of the anode above the threshold voltage VAth of the light emitting device ED, a high-level EM_VGH2, which is greater than the first high level EM_VGH1, can be used as the second off-level EM_OFF2 pulse, as illustrated in FIG. 10.

When the second high level EM_VGH2, which is greater than the first high level EM_VGH1, is supplied to the gate of the first light emitting transistor T4, the voltage of the anode can be increased by a difference value between the first low level EM_VGL of the first on-level EM_ON1 pulse and the second high level EM_VGH2.

Therefore, the voltage of the anode can be increased by H2, which is greater than H1, and, accordingly, light having a luminance corresponding to a low grayscale level can be output from the light emitting device ED.

To provide an additional description, in the light emitting display apparatus according to the present disclosure, the anode voltage can be increased by increasing the off-level EM_OFF supplied to the first light emitting transistor T4, and accordingly, when the grayscale level of the pixel P is changed from low grayscale level to high grayscale level, the luminance corresponding to the high grayscale level can be normally expressed.

To illustrate, an example in which the second off-level EM_OFF2 pulse is increased has been described in FIG. 10. However, as described with reference to FIG. 8, while the first off-level EM_OFF1 pulse is being supplied, the fourth node N4 is reset by the anode reset voltage VAR, and the anode reset voltage VAR is a voltage much lower than the threshold voltage of the light emitting device ED. Therefore, as described with reference to FIG. 10, when the second off-level EM_OFF2 pulse is supplied, even if the high level EM_VGH2, which is greater than the first high level EM_VGH1, is supplied to the gate of the first light emitting transistor T4, the effect of the kickback may not be sufficiently generated.

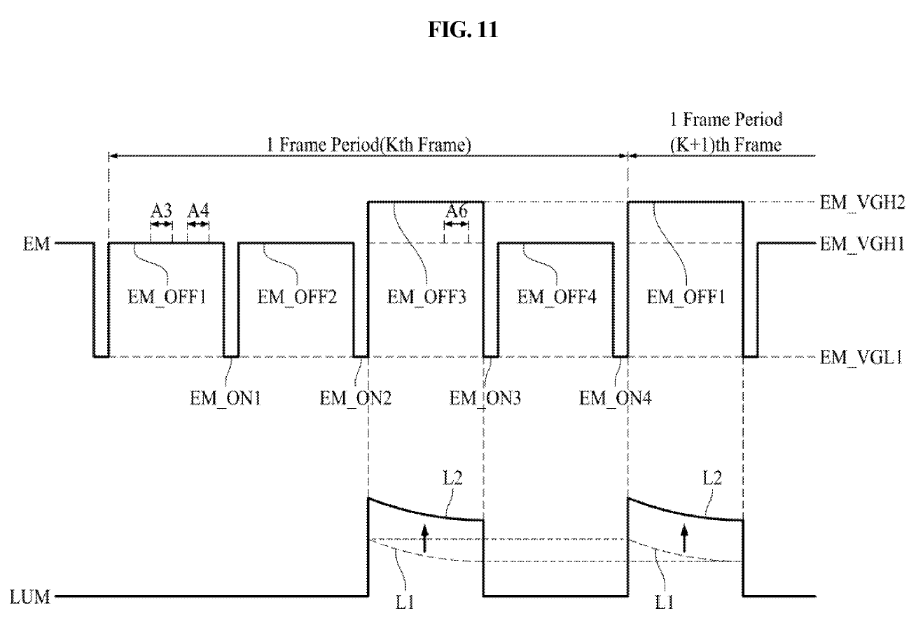

That is, FIG. 10 is an exemplary diagram for explaining a basic driving method of a light emitting display apparatus according to the present disclosure, and a specific driving method of a light emitting display apparatus according to the present disclosure will be described below with reference to FIGS. 11 to 14.

In the following descriptions, details that are the same as or similar to those described with reference to FIGS. 1 to 10 are omitted or briefly described.

FIG. 11 is an exemplary diagram illustrating a driving method of a light emitting display apparatus according to an embodiment of the present disclosure, and, in particular, an exemplary diagram illustrating signals applied to a light emitting display apparatus driven in a low luminance mode.

As described above, in the light emitting display apparatus according to an embodiment of the present disclosure, the mode conversion luminance (N%) is set, and the user-set luminance can be changed by a user. Furthermore, in the light emitting display apparatus according to an embodiment of the present disclosure, in the low luminance mode outputting light having a luminance the same as or less than the mode conversion luminance, the luminance of light is controlled by the PWM method, and accordingly, for example, grayscale levels 0 to 255 can be expressed.

First, in a light emitting display apparatus according to an embodiment of the present disclosure, the difference between the high level EM_VGH and the low level EM_VGL of the light emitting signal EM in the low luminance mode is greater than the difference between the first high level EM_VGH1 and the first low level EM_VGL1 of the light emitting signal EM in the high luminance mode.

For example, even when the light emitting display apparatus according to an embodiment of the present disclosure is driven in the high luminance mode, a high level voltage and a low level voltage can be used in order to generate the light emitting signal EM. In the following description, the high level voltage and the low level voltage used for generating the light emitting signal EM in the high luminance mode are referred to as a first high level EM_VGH1 voltage and a first low level EM_VGL1 voltage. The first high level EM_VGH1 voltage and the first low level EM_VGL1 voltage can also be used for generating the light emitting signal EM in the low luminance mode.

As described above with reference to FIG. 10, the kickback can mean that the voltage of the second terminal N4 of the first light emitting transistor T4 (that is, the voltage of the anode) increases as much as the voltage applied to the gate of the first light emitting transistor T4 increases.

For example, as illustrated in FIG. 11, the difference between the second high level EM_VGH2 voltage and the first low level EM_VGL1 voltage of the light emitting signal EM applied in the low luminance mode can be greater than the difference (hereinafter, simply referred to as a first difference value) between the first high level EM_VGH1 voltage and the first low level EM_VGL1 voltage of the light emitting signal EM applied in the high luminance mode.

Thus, when the light emitting signal voltage EM is changed from the low level EM_VGL1 to the high level EM_VGH2 in the low luminance mode, the voltage of the anode (the fourth node N4) can be increased more than in the high luminance mode, and thus light having the luminance corresponding to the high grayscale level can be output.

Second, in the following description, the light emitting signal voltage EM can include on-levels EM_ON that turn on the first light emitting transistor T4 and off-levels EM_OFF that turn off the first light emitting transistor T4.

In addition, in the low luminance mode, the gate driver 200 can transmit at least four on-level EM_ON pulses and at least four off-level EM_OFF pulses to the gate of the first light emitting transistor T4 in the kth frame (k is a natural number).

Hereinafter, for convenience of description, a light emitting display apparatus that transmits four on-level pulses EM_ON1 to EM_ON4 and four off-level pulses EM_OFF1 to EM_OFF4 to the gate of the first light emitting transistor T4 is described as an example of a light emitting display apparatus according to the present disclosure, as illustrated in FIG. 11.

In the following description, one frame period can mean a period in which all light emitting devices ED provided on the light emitting display panel 100 are driven and one image is output, and the kth frame and the (k+1)th frame can mean an order of one frame period. For example, each of the kth frame and the (k+1)th frame can mean a one frame period, the (k-1)th frame can mean a one frame period, which occurs before the kth frame, and the (k+1)th frame can mean a one frame period, which occurs after the kth frame.

Third, as described above, in the light emitting display apparatus according to an embodiment of the present disclosure, the width (duration) of the off-level EM_OFF (or on-level EM_ON) pulse can be changed depending on the grayscale level of light to be output from the light emitting device.

Fourth, when the average grayscale level of pixels in the kth frame is higher than the average grayscale level of pixels in the (k-1)th frame, the difference between the high level EM_VGH and the low level EM_VGL of the light emitting signal EM supplied in the kth frame of the low luminance mode is greater than the difference between the first high level EM_VGH1 and the first low level EM_VGL1.

For example, in the low luminance mode, the control unit 400 can compare the average grayscale level of pixels in the kth frame with the average grayscale level of pixels in the (k-1)th frame.

When the average grayscale level of pixels in the kth frame is higher than the average grayscale level of pixels in the (k-1)th frame, the control unit 400 can control the power supply unit 500 to supply the second high level EM_VGH2, which is greater than the first high level EM_VGH1, or the second low level EM_VGL2, which is lower than the first low level EM_VGL1, or the second high level EM_VGH2, which is greater than the first high level EM_VGH1, and the second low level EM_VGL2, which is lower than the first low level EM_VGL1 to the gate driver 200.

To provide an additional description, in the light emitting display apparatus according to an embodiment of the present disclosure, when high-grayscale level light is output after low-grayscale level light is output in the low luminance mode, the difference between the high level EM_VGH and the low level EM_VGL of the light emitting signal EM can be greater than the first difference value between the first high level EM_VGH1 and the first low level EM_VGL1. Accordingly, light having a luminance corresponding to a high grayscale level can be normally output from the light emitting device ED.

Fifth, hereinafter, a method of driving a light emitting display apparatus according to an embodiment of the present disclosure will be described in detail with reference to FIG. 11. The following description can be applied to a light emitting display apparatus including the pixel P illustrated in FIG. 2, and thus, can be applied when the first light emitting transistor T4 is a P-type transistor.

In the kth frame, the first to fourth scan signals SC1 to SC4 described with reference to FIGS. 8 and 10 together with the light emitting signal EM illustrated in FIG. 11 can be supplied to the pixel P.

A high level and a low level used to generate the light emitting signal EM in the high luminance mode are referred to as a first high level EM_VGH1 and a first low level EM_VGL1, and the first high level EM_VGH1 and the first low level EM_VGH1 can also be applied to the low luminance mode, as illustrated in FIG. 11.

In the kth frame, four off-levels EM_OFF1 to EM_OFF4 and four on-levels EM_ON1 to EM_ON4 can be supplied to the gate of the first light emitting transistor T4.

Hereinafter, for convenience of description, the third off-level EM_OFF3, which is supplied as third among the four off-levels EM_OFF1 to EM_OFF4, is referred to as a kickback off-level. Accordingly, the reference numeral EM_OFF3 can be assigned to the kickback off-level.

First, when a kth frame starts, a first off-level EM_OFF1 is supplied. The first off-level EM_OFF1 can be a first high level EM_VGH1.

While the first off-level EM_OFF1 is supplied, the scan signals SC1 to SC4 as described with reference to FIGS. 8 and 10 are supplied, and accordingly, the anode is reset by the anode reset voltage VAR, and the gate of the driving transistor Tdr can be charged with a data voltage Vdata.

Next, a first on-level EM_ON1 is supplied. The first on-level EM_ON1 can have a first low level EM_VGL1. Even if the first on-level EM_ON1 is supplied, light may not be output from the light emitting device ED.

Next, a second off-level EM_OFF2 is supplied. The second off-level EM_OFF2 can have the first low level EM_VGH1.

Next, a second on-level EM_ON2 is supplied. The second on-level EM_ON2 can have a first low level EM_VGL1. Even if the second on-level EM_ON2 is supplied, light may not be output from the light emitting device ED.

Next, a third off-level EM_OFF3 is supplied. As described above, the third off-level EM_OFF3 is referred to as a kickback off-level. The kickback off-level EM_OFF3 can be a second high level EM_VGH2, and the second high level EM_VGH2 is higher than the first high level EM_VGH1.

In this case, the difference between the first low level EM_VGL1 of the second on-level EM_ON2 and the second high level EM_VGH2 of the kickback off-level EM_OFF3 is greater than the first difference value between the first high level EM_VGH1 and the first low level EM_VGL1.

Therefore, light having a second luminance L2, which is greater than a first luminance L1 and which is generated when the first low level EM_VGL1 and the first high level EM_VGH1 are supplied, can be output from the light emitting device ED.

In this case, the difference between the on-level supplied before the kickback off-level EM_OFF3 and the second high level EM_VGH2 is greater than the first difference value between the first high level EM_VGH1 and the first low level EM_VGL1. Here, the on-level can be a low level of the second on-level EM_ON2, for example, the first low level EM_VGL1.

The sixth period A6 is included in a period in which the third off-level EM_OFF3 is supplied. Accordingly, in the sixth period A6, the voltage of the anode, that is, the voltage of the fourth node N4 is reset by the anode reset voltage VAR.

Next, a third on-level EM_ON3 is supplied. The third on-level EM_ON3 can have the first low level EM_VGL1. Because the voltage of the anode is reset to the anode reset voltage VAR during the sixth period A6, even if the third on-level EM_ON3 is supplied, light may not be output from the light emitting device ED, and light may not be output from the light emitting device ED even at the time when a fourth off-level EM_OFF4 is supplied.

Next, after the fourth off-level pulse EM_OFF4 is supplied, a fourth on-level EM_ON4 pulse is supplied. The fourth on-level EM_ON4 can have the first low level EM_VGL1. Even if the fourth on-level EM_ON4 is supplied, light may not be output from the light emitting device ED.

Finally, the (k+1)th frame is started, and a first off-level EM_OFF1 of the (k+1)th frame is supplied. The first off-level EM_OFF1 of the (k+1)th frame can become the second high level EM_VGH2.

In this case, the difference between the first low level EM_VGL1 of the fourth on-level EM_ON4 and the second high level EM_VGH2 of the first off-level EM_OFF1 of the (k+2)th frame is greater than the first difference value between the first high level EM_VGH1 and the first low level EM_VGL1.

In this case, the voltage of the anode can be further increased by the kickback. Accordingly, light having a second luminance L2 greater than a first luminance L1, which is generated when the first low level EM_VGL1 and the first high level EM_VGH1 are supplied, can be output from the light emitting device ED.

As described above, the anode reset transistor T6 can be connected between the anode reset line to which the anode reset voltage VAR is supplied and the first terminal of the light emitting device ED.

While the kickback off-level EM_OFF3 voltage is supplied to the gate of the first light emitting transistor T4, the anode reset transistor T6 can be turned on. That is, the sixth period A6 is included in the period in which the kickback off-level EM_OFF3 voltage is supplied.

Accordingly, in the sixth period A6 included in the period in which the kickback off-level EM_OFF3 pulse is supplied, the voltage of the anode, that is, the voltage of the fourth node N4, is reset to the anode reset voltage VAR.

Among the off-levels EM_OFF supplied in the kth frame, the off-levels EM_OFF except for the kickback off-level EM_OFF3 are referred to as normal off-levels. For example, the first off-level EM_OFF1, the second off-level EM_OFF2, and the fourth off-level EM_OFF4 in the kth frame can be the normal off-level. The normal off-level can be the same as the first high level EM_VGH1.

In the off-levels EM_OFF supplied in the (k+1)th frame, the second off-level EM_OFF2 and a fourth off-level EM_OFF4 can be the normal off-levels. That is, the normal off-level can be the off-level EM_OFF having the first high level EM_VGH1.

After the kickback off-level EM_OFF3 having the second high level EM_VGH2 is supplied to the gate of the first light emitting transistor T4, the normal off-level (e.g., the fourth off-level EM_OFF4) having the first high level EM_VGH1 can be supplied to the gate of the first light emitting transistor T4.

While a start off-level is supplied to the gate of the first light emitting transistor T4 after the kth frame starts, a data voltage can be supplied to the gate of the driving transistor Tdr.

For example, the first off-level EM_OFF1 supplied in the kth frame can be the start off-level.

A data voltage can be supplied to the gate of the driving transistor Tdr during a third period A3 included in the period in which the first off-level EM_OFF1 is supplied.

As described above, the normal off-level among the off-levels in the low luminance mode can be the same as the first high level EM_VGH1.

Also, the normal off-level (e.g., the second off-level EM_OFF2) can be supplied to the gate of the first light emitting transistor T4 between the first off-level EM_OFF1 and the kickback off-level EM_OFF3.

A start off-level supplied to the gate of the first light emitting transistor T4 in the (k+1)th frame generated after the kth frame can be the same as the second high level EM_VGH2.

For example, as described above, the first off-level EM_OFF1 of the (k+1)th frame can be the second high level EM_VGH2. Accordingly, the start off-level supplied in the (k+1)th frame can be the kickback off-level. For example, in the (k+1)th frame, the first off-level EM_OFF1 and a third off-level EM_OFF3 can be the kickback off-level.

According to the light emitting display apparatus as described above, the off-level supplied after the second on-level EM_ON2 and the fourth on-level EM_ON4 are supplied can become the second high level EM_VHG2 which is greater than the first high level EM_VGH1. Accordingly, the difference between the second high level EM_VGH2 and the first low level EM_VGL1 in the low luminance mode can be greater than the first difference value between the first high level EM_VGH1 and the first low level EM_VGL1.

In this case, the second luminance L2 of light output by the kickback after the second on-level EM_ON2 and the fourth on-level EM_ON4 are supplied can be greater than the first luminance L1 of light output by the conventional kickback.

Therefore, even if the grayscale level of the pixel P is changed from a low grayscale level to a high grayscale level, light having a luminance corresponding to the high grayscale level can be normally output.

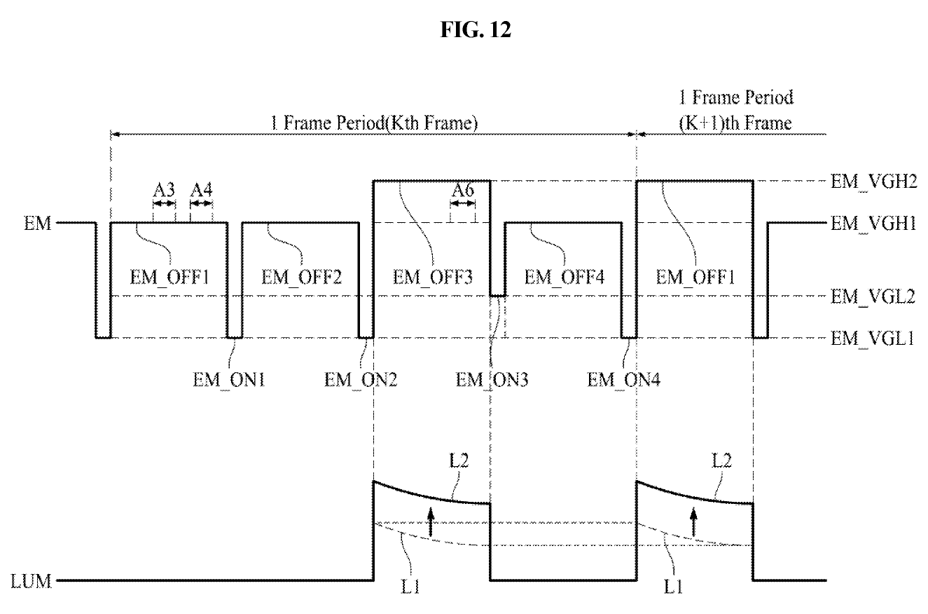

FIG. 12 is another exemplary diagram for explaining a driving method of a light emitting display apparatus according to an embodiment of the present disclosure, and in particular, is an exemplary diagram illustrating signals applied to a light emitting display apparatus driven in a low luminance mode. Compared with an embodiment illustrated in FIG. 11, in an embodiment illustrated in FIG. 12, a low level EM_VGL of a third on-level EM_ON3 supplied after a kickback off-level EM_OFF3 can become a second low level EM_VGL2 higher than a first low level EM_VGL1. Except for the above differences, the descriptions described with reference to FIG. 11 can also be applied to the embodiment illustrated in FIG. 12. Therefore, hereinafter, the above differences are mainly described.

As described above with reference to FIG. 11, after the second on-level EM_ON2 pulse is supplied, the third off-level EM_OFF3 pulse is supplied. The third off-level EM_OFF3 can be the kickback off-level. The second high level EM_VGH2 of the kickback off-level EM_OFF3 pulse is greater than the first high level EM_VGH1.

In this case, the difference between the first low level EM_VGL1 of the second on-level EM_ON2 and the second high level EM_VGH2 of the kickback off-level EM_OFF3 is greater than the first difference value between the first high level EM_VGH1 and the first low level EM_VGL1.

Therefore, light having a second luminance L2, which is greater than a first luminance L1, is generated when the first low level EM_VGL1 and the first high level EM_VGH1 are supplied, can be output from the light emitting device ED.

A sixth period A6 is included in a period in which the kickback off-level EM_OFF3 is supplied. Accordingly, in the sixth period A6, the voltage of the anode, that is, the voltage of the fourth node N4 is reset to the anode reset voltage.

In this case, if the third on-level EM_ON3 supplied after the kickback off-level EM_OFF3 drops to the first low level EM_VGL1, the voltage of the fourth node N4 also drops significantly due to the kickback. Accordingly, the second luminance L2 can be greatly reduced instantaneously.

To prevent this, as illustrated in FIG. 12, a low level of a third on-level EM_ON3 supplied after the kickback off-level EM_OFF3 can become a second low level EM_VGL2 greater than the first low level EM_VGL1.

For example, the second low level of the on-level (e.g., the third on-level EM_ON3) supplied to the gate of the first light emitting transistor T4 after the kickback off-level EM_OFF3 is supplied can be higher than the first low level EM_VGL1.

In other words, the low level of the on-level (e.g., the second on-level EM_ON2) supplied to the gate of the first light emitting transistor T4 immediately before the kickback off-level EM_OFF3 can be the first low level EM_VGL1, and the second low level EM_VGL2 of the on-level (e.g., the third on-level EM_OFF3) supplied to the gate of the first light emitting transistor T4 after the kickback off-level EM_OFF3 can be higher than the first low level EM_VGL1.

If the third on-level EM_ON3 having the second low level EM_VGL2, which is greater than the first low level EM_VGL1, is supplied after the kickback off-level EM_OFF3, the decrease in the amount of the second luminance L2 that is due to the kickback can be reduced. Therefore, even if the grayscale level of the pixel P is changed from a low grayscale level to a high grayscale level, light having the luminance corresponding to the high grayscale level can be normally output.

In this case, a low-level of a first on-level EM_ON1 supplied in the (k+1)th frame can be the first low-level EM_VGL1 or the second low-level EM_VGL2.

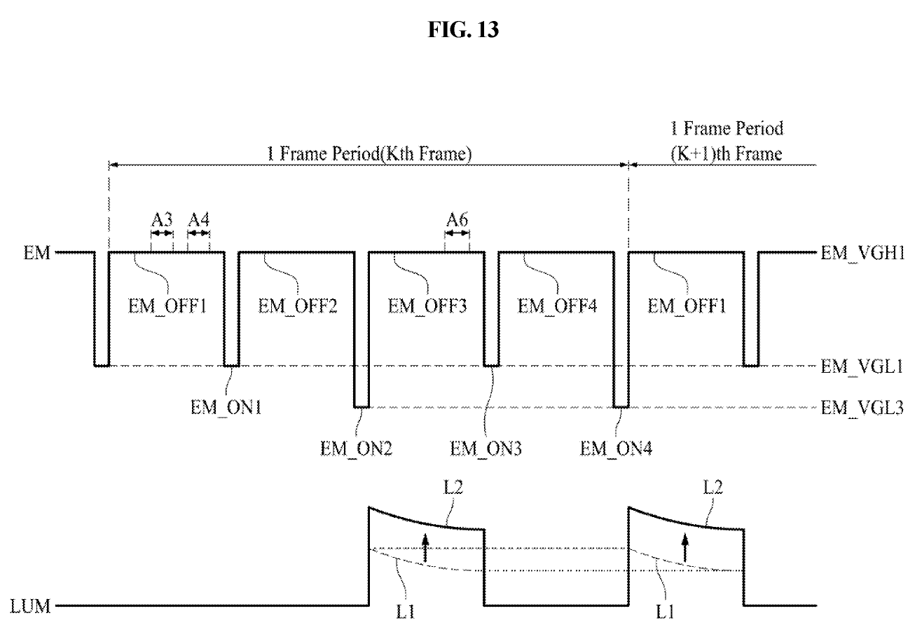

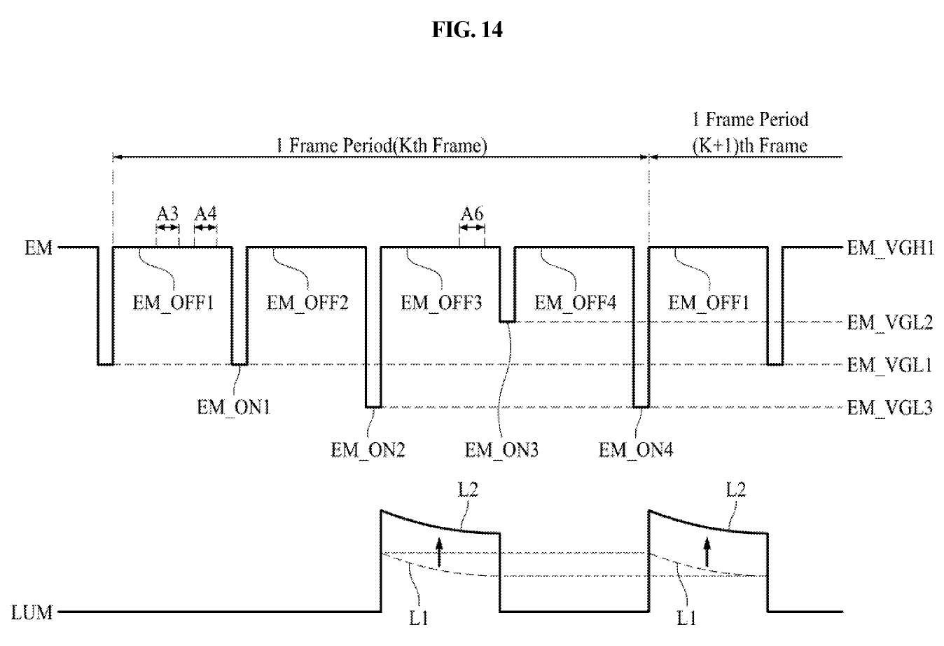

FIGS. 13 and 14 are other exemplary diagrams for describing a method for driving a light emitting display apparatus according to an embodiment of the present disclosure, and in particular, are exemplary diagrams illustrating signals applied to a light emitting display apparatus driven in a low luminance mode. Compared with an embodiment illustrated in FIG. 11, in embodiments illustrated in FIG. 13 and FIG. 14, the low level EM_VGL of the second on-level EM_ON2 supplied before the kickback off-level EM_VGL1 can be a third low level EM_VGL3, which is lower than the first low level EM_VGL1. For example, the low level of the on-level (e.g., the second on-level EM_ON2) supplied to the gate of the first light emitting transistor T4 immediately before the kickback off-level EM_OFF3 among the off-levels can be a third low level EM_VGL3, which is lower than the first low level.

Except for the above difference, the descriptions described with reference to FIG. 11 can also be applied to embodiments illustrated in FIGS. 13 and 14. Hereinafter, the above difference will be described.

As described above with reference to FIG. 11, the third off-level EM_OFF3 is supplied after the second on-level EM_ON2 is supplied. The third off-level EM_OFF3 can be the kickback off-level.

In this case, as illustrated in FIGS. 13 and 14, the third low level EM_VGL3 of the second on-level EM_ON2 is lower than the first low level EM_VGL1.

Accordingly, the difference between the third low level EM_VGL3 of the second on-level EM_ON2 and the first high level EM_VGH1 of the kickback off-level EM_OFF3 is greater than the first difference value between the first high level EM_VGH1 and the first low level EM_VGL1.

Therefore, as illustrated in FIGS. 13 and 14, light having a second luminance L2 that is greater than a first luminance L1, which is generated when the first low level EM_VGL1 and the first high level EM_VGH1 are supplied, can be output from the light emitting device ED.

Therefore, even if the grayscale level of the pixel P is changed from a low grayscale level to a high grayscale level, light having a luminance corresponding to the high grayscale level can be normally output.

Also, a low level of a fourth on-level EM_ON4 supplied after a fourth off-level EM_OFF4 is supplied can have the third low level EM_VGL3.

Accordingly, the difference between the third low level EM_VGL3 of the fourth on-level EM_ON4 and the first high level EM_VGH1 of a first off-level EM_OFF1 of the (k+1)th frame is greater than the first difference value between the first high level EM_VGH1 and the first low level EM_VGL1.

Therefore, as illustrated in FIGS. 13 and 14, light having a second luminance L2 greater than a first luminance L1, which is generated when the first low level EM_VGL1 and the first high level EM_VGH1 are supplied, can be output from the light emitting device ED. A sixth period A6 is included in a period in which the kickback off-level EM_OFF3 is supplied. Therefore, in a sixth period A6, the voltage of the anode, that is, the voltage of the fourth node N4, is reset to the anode reset voltage VAR.

In this case, if the third on-level EM_ON3 supplied after the kickback off-level EM_OFF3 drops to the first low level EM_VGL1, the voltage of the fourth node N4 also drops significantly due to the kickback. Accordingly, the second luminance L2 can be greatly reduced instantaneously.

To prevent this, as illustrated in FIG. 14, the low level of the third on-level EM_ON3 supplied after the kickback off-level EM_OFF3 can become the second low level EM_VGL2 greater than the first low level EM_VGL1.

For example, the second low level EM_VGL2 of the on-level (e.g., the third on-level EM_ON3) supplied to the gate of the first light emitting transistor T4 after the kickback off-level EM_OFF3 is supplied can be higher than the first low level EM_VGL1.

To provide an additional description, the low level of the on-level (e.g., the second on-level EM_ON2) supplied to the gate of the first light emitting transistor T4 immediately before the kickback off-level EM_OFF3 can be the third low level EM_VGL3, which is lower than the first low level EM_VGL1, and the second low level EM_VGL2 of the on-level (e.g., the third on-level EM_OFF3) supplied to the gate of the first light emitting transistor T4 after the kickback off-level EM_OFF3 can be higher than the first low level EM_VGL1.

If the third on-level EM_ON3 having the second low level EM_VGL2 greater than the first low level EM_VGL1 is supplied after the kickback off-level EM_OFF3, the decrease amount of the second luminance L2 can be reduced.

Accordingly, even if the grayscale level of the pixel P is changed from a low grayscale level to a high grayscale level, light having a luminance corresponding to the high grayscale level can be normally output (i.e., distortion due to kickback is prevented).

In this case, a low level of a first on-level EM_ON1 supplied in the (k+1)th frame can be the first low level EM_VGL1 or the second low level EM_VGL2.

As described above, in the light emitting display apparatus according to an embodiment of the present disclosure, the mode conversion luminance (N%) is set, and the user-set luminance can be changed by a user. Furthermore, in the light emitting display apparatus according to an embodiment of the present disclosure, in the low luminance mode outputting light having a luminance the same as or less than the mode conversion luminance, the luminance of light is controlled by the PWM method, and accordingly, for example, grayscale levels 0 to 255 can be expressed.

In particular, the above-described contents can be applied when a high grayscale level is expressed after a low grayscale level in the low luminance mode.

In this case, the control unit 400 can compare the average grayscale level of the (k-1)th frame with the average grayscale level of the kth frame. When the average grayscale level is increased, for example, in all cases where the average grayscale level is changed from a low grayscale level to a high grayscale level, the control unit 400 can control the power supply unit 500 to supply at least one of the second high level EM_VGH2, the second low level EM_VGL2, and the third low level EM_VGL3 to the pixel P through the gate driver, as described above.

However, the control unit 400 can control the power supply unit 500 so that at least one of the second high level EM_VGH2, the second low level EM_VGL2, and the third low level EM_VGL3 can be supplied to the pixel P through the gate driver 200 only when the average grayscale level of the kth frame is greater than the average grayscale level of the (k-1) frame and the average grayscale level of the kth frame and the average grayscale level of the (k-1)th frame are included in a specific range among all grayscale levels (e.g., grayscale levels 0 to 255).

Furthermore, when the average grayscale level of the kth frame is lower than the average grayscale level of the (k-1)th frame, the control unit 400 can supply the third high level lower than the first high level EM_VGH1 to the pixel P instead of the second high level EM_VGH2, and can supply a fourth low level higher than the first low level EM_VGL1 to the pixel P instead of the third low level EM_VGL3. Accordingly, even when the average grayscale level of the kth frame is lower than the average grayscale level of the (k-1)th frame, light having the luminance corresponding to the low grayscale level can be normally output.

The features of the light emitting display apparatus according to an embodiment of the present disclosure are briefly summarized as follows.

A light emitting display apparatus according to an embodiment of the present disclosure comprises a pixel including a driving transistor, a light emitting device, and a first light emitting transistor connected between a first terminal of the driving transistor and a first terminal of the light emitting device and a gate driver configured to supply a light emitting signal for turning the first light emitting transistor on or off to a gate of the first light emitting transistor, wherein in a low-luminance mode that outputs light having a luminance equal to or lower than a predetermined mode conversion luminance, a difference between a high level and a low level of a light emitting signal is greater than a first difference value, which is a difference between a first high level and a first low level of a light emitting signal in a high-luminance mode that outputs light having a luminance exceeding the mode conversion luminance.

In the low luminance mode, the gate driver outputs the light emitting signal in which at least four on-levels and at least four off-levels alternately occur in a kth frame (where k is a natural number).

A width of each of the off-levels changes depending on a grayscale level.

When an average grayscale level of pixels in a kth frame is higher than an average grayscale level of pixels in a (k−1)th frame, a difference between a high level and a low level of the light emitting signal supplied in the kth frame in the low luminance mode is greater than the first difference value.

When the first light emitting transistor is a P-type transistor, each of the off-levels is a high level, each of the on-levels is a low level, and a kickback off-level among the off-levels is greater than the first high level.

A difference between an on-level supplied immediately before the kickback off-level of the light emitting signal and the kickback off-level is greater than the first difference value.

The pixel further includes an anode reset transistor connected between an anode reset line to which an anode reset voltage is supplied and a first terminal of the light emitting device, and the anode reset transistor is turned on while the kickback off-level is supplied to a gate of the first light emitting transistor.

Among the off-levels in the low luminance mode, a normal off-level other than the kickback off-level is the same as the first high level.

After the kickback off-level is supplied to a gate of the first light emitting transistor, the normal off-level is supplied to the gate of the first light emitting transistor.

While a start off-level is supplied to a gate of the first light emitting transistor after a kth frame starts, a data voltage is supplied to a gate of a driving transistor.

Among the off-levels in the low luminance mode, a normal off-level other than the kickback off-level is the same as the first high level, and the normal off-level is supplied to the gate of the first light emitting transistor between the first off-level and the kickback off-level.

A start off-level supplied to the gate of the first light emitting transistor in a (k+1)th frame generated after the kth frame is the same as the second high level.

An on-level supplied to a gate of the first light emitting transistor after the kickback off-level is greater than the first low level.

An on-level supplied to a gate of the first light emitting transistor immediately before the kickback off-level is the first low level, and an on-level supplied to the gate of the first light emitting transistor after the kickback off-level is greater than the first low level.

When the first light emitting transistor is a P-type transistor, an on-level supplied to a gate of the first light emitting transistor immediately before the kickback off-level among the off-levels is lower than the first low level.

An on-level supplied to the gate of the first light emitting transistor after the kickback off-level is greater than the first low level.

The light emitting display apparatus according to an embodiment of the present disclosure can be applied to all electronic devices that include a light emitting display panel. For example, the light emitting display apparatus according to the present disclosure can be applied to a virtual reality (VR) device, an augmented reality (AR) device, a mobile device, a video phone, a smart watch, a watch phone, or a wearable device, foldable device, rollable device, bendable device, flexible device, curved device, electronic notebook, e-book, PMP (portable multimedia player), PDA (personal digital assistant), MP3 player, mobile medical device, desktop PC, laptop PC, netbook computer, workstation, navigation, car navigation, vehicle display devices, televisions, wall paper display devices, signage devices, game devices, laptops, monitors, cameras, camcorders, and home appliances.

According to a light emitting display apparatus according to an embodiment of the present disclosure, response characteristics of a light emitting device can be improved in a low luminance mode of a light emitting display apparatus using a PWM method. Accordingly, light can be normally output in the low luminance mode.

In particular, when the grayscale level of a pixel changes from a low grayscale level to a high grayscale level in a low luminance mode, a light emitting device can respond quickly, and accordingly, high-grayscale level light can be normally output in the low luminance mode.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A light emitting display apparatus comprising:
a pixel including a driving transistor, a light emitting device, and a first light emitting transistor connected between a first terminal of the driving transistor and a first terminal of the light emitting device; and
a gate driver configured to supply a light emitting signal for turning the first light emitting transistor on or off to a gate of the first light emitting transistor,
wherein when the light emitting display apparatus is in a low-luminance mode that outputs light having a luminance equal to or lower than a predetermined mode conversion luminance, a difference between a high voltage level and a low voltage level of a light emitting signal is greater than a first difference value, which is a difference between a first high voltage level and a first low voltage level of a light emitting signal when the light emitting display apparatus is in a high-luminance mode that outputs light having a luminance exceeding the mode conversion luminance.

2. The light emitting display apparatus of claim 1, wherein
in the low-luminance mode, the gate driver outputs the light emitting signal in which at least four on-level voltage pulses and at least four off-level voltage pulses alternately occur in a kth frame (where k is a natural number).

3. The light emitting display apparatus of claim 2, wherein a duration of each of the off-levels changes depending on a grayscale level.

4. The light emitting display apparatus of claim 1, wherein
when an average grayscale level of pixels in a kth frame is higher than an average grayscale level of pixels in a (k−1)th frame,
a difference between a high voltage level and a low voltage level of the light emitting signal supplied in the kth frame in the low-luminance mode is greater than the first difference value.

5. The light emitting display apparatus of claim 2, wherein
when the first light emitting transistor is a P-type transistor,
each of the off-level voltage pulses is a high voltage level pulse, each of the on-level voltage pulses is a low level voltage pulse, and a voltage of a kickback off-level voltage pulse among the off-level voltage pulses is greater than the first high voltage level.

6. The light emitting display apparatus of claim 5, wherein
a difference between a voltage of an on-level voltage pulse supplied immediately before the kickback off-level voltage pulse of the light emitting signal and a voltage of the kickback off-level voltage pulse is greater than the first difference value.

7. The light emitting display apparatus of claim 5, wherein
the pixel further includes an anode reset transistor connected between an anode reset line to which an anode reset voltage is supplied and a first terminal of the light emitting device, and
the anode reset transistor is turned on while the kickback off-level voltage pulse is supplied to a gate of the first light emitting transistor.

8. The light emitting display apparatus of claim 5, wherein
among the off-level voltage pulses in the low-luminance mode, a voltage of all off-level voltage pulses other than the kickback off-level voltage pulse, termed normal pulses, are the same as the first high voltage level.

9. The light emitting display apparatus of claim 8, wherein
after the kickback off-level voltage pulse is supplied to a gate of the first light emitting transistor, the normal off-level voltage pulse is supplied to the gate of the first light emitting transistor.

10. The light emitting display apparatus of claim 5, wherein
while a start off-level voltage pulse is supplied to a gate of the first light emitting transistor after a kth frame starts, a data voltage is supplied to a gate of a driving transistor.

11. The light emitting display apparatus of claim 10, wherein
among the off-level voltage pulses in the low-luminance mode,
a voltage of a normal off-level voltage pulse other than the kickback off-level voltage pulse is the same as the first high voltage level, and
the normal off-level voltage pulse is supplied to the gate of the first light emitting transistor between the first off-level voltage pulse and the kickback off-level voltage pulse.

12. The light emitting display apparatus of claim 11, wherein
a start off-level voltage pulse supplied to the gate of the first light emitting transistor in a (k+1)th frame generated after the kth frame is the same as a second high voltage level of a light emitting signal in the (k+1)th frame when the light emitting display apparatus is in a high-luminance mode that outputs light having a luminance exceeding the mode conversion luminance.

13. The light emitting display apparatus of claim 5, wherein
an on-level voltage pulse supplied to a gate of the first light emitting transistor after the kickback off-level voltage pulse is greater than the first low voltage level.

14. The light emitting display apparatus of claim 5, wherein
a voltage of an on-level voltage pulse supplied to a gate of the first light emitting transistor immediately before the kickback off-level voltage pulse is the first low voltage level, and
a voltage of an on-level voltage pulse supplied to the gate of the first light emitting transistor after the kickback off-level voltage pulse is greater than the first low voltage level.

15. The light emitting display apparatus of claim 2, wherein
when the first light emitting transistor is a P-type transistor,
an on-level voltage pulse supplied to a gate of the first light emitting transistor immediately before the kickback off-level voltage pulse among the off-level voltage pulses is lower than the first low voltage level.

16. The light emitting display apparatus of claim 15, wherein
an on-level voltage pulse supplied to the gate of the first light emitting transistor after the kickback off-level voltage pulses is greater than the first low voltage level.

17. A light emitting display apparatus, comprising:
a display panel;
a gate driver that supplies scan voltage signals to a plurality of scan lines provided to serve the display panel;
a data driver that supplies data voltages to a plurality of data lines provided to serve the display panel;
a control unit that controls driving of the gate driver and the data driver; and
a power supply that supplies power to the control unit, the gate driver, the data driver and the display panel,
wherein the display panel includes a plurality of pixels, each pixel comprising:
a driving transistor;
a light emitting device;
a first light emitting transistor, a source of the first light emitting transistor being connected to a drain of the driving transistor, a drain of the first light emitting transistor being connected to an anode of the light emitting device, a gate of the first light emitting transistor being connected to a first scan line known as a light emitting signal line;
a first voltage source;
a second light emitting transistor, a source of the second light emitting transistor being connected to the first voltage source, a drain of the second light emitting transistor being connected to the source of the driving transistor, a gate of the second light emitting transistor being connected to the light emitting signal line;
a capacitor interposed between and directly connected to each of the first voltage source and a gate of the driving transistor;
a first switching transistor interposed between the source of the driving transistor and a data line providing data voltages, a gate of the first switching transistor being connected to a second scan line providing scan voltage signals;
an on-bias stress transistor interposed between the source of the driving transistor and an on-bias stress voltage source, a gate of the on-bias stress transistor being connected to a third scan line providing scan voltage signals; and
a reset transistor interposed between a drain of the second light emitting transistor and the anode of the light emitting device, a gate of the reset transistor being connected to the third scan line,
wherein providing an on-bias stress voltage from the on-bias stress voltage source to the driving transistor reduces a change in characteristics of the driving transistor due to hysteresis.

18. The light emitting display apparatus of claim 17, further comprising:
an initialization transistor interposed between the gate of the driving transistor and an initialization voltage source, a gate of the initialization transistor being connected to a fourth scan line;
a threshold voltage compensation transistor interposed directly between the gate and a drain of the driving transistor, a gate of the threshold voltage compensation transistor being connected to a fifth scan line; and
a second voltage source connected to a cathode of the light emitting device.

19. A method of improving picture quality in a light emitting display apparatus, comprising:
providing a light emitting display apparatus wherein:
the light emitting display apparatus has a plurality of pixels, each pixel including one or more light emitting transistor(s), wherein voltage signals via a light emission signal line to a gate of each light emitting transistor causes light emission by the pixel to turn on and turn off; and
the light emitting display apparatus can operate in a low luminance mode when luminance is equal to or lower than a predetermined mode conversion luminance or can operate in a high luminance mode when luminance is higher than the mode conversion luminance, and
controlling light emission of the pixel by applying a light emitting voltage signal to the light emission signal line, wherein when the light emitting display apparatus is in the low luminance mode, a difference between a high voltage level and a low voltage level of a light emitting signal is greater than a first difference value, which is a difference between a first high voltage level and a first low voltage level of a light emitting signal when the light emitting display apparatus is in the high luminance mode.

20. The method of claim 19, wherein when the light emitting display apparatus is in the low luminance mode, the light emitting voltage signal features at least four on-level voltage pulses and at least four off-level voltage pulses that alternately occur in a kth frame (where k is a natural number).
